(19) United States
(12) Patent Application Publication
(10) Pub. No.: US 2023/0314868 A1
(43) Pub. Date: Oct. 5, 2023

(54) LIQUID CRYSTAL DISPLAY DEVICE

(71) Applicant: Sharp Display Technology Corporation, Kameyama City (JP)

(72) Inventors: Akira SAKAI, Kameyama City (JP); Ryosuke SAIGUSA, Kameyama City (JP); Yuichi KAWAHIRA, Kameyama City (JP); Masahiro HASEGAWA, Kameyama City (JP); Kiyoshi MINOURA, Kameyama City (JP)

(21) Appl. No.: 18/127,549

(22) Filed: Mar. 28, 2023

(30) Foreign Application Priority Data
Mar. 30, 2022 (JP) 2022-055724

(51) Int. Cl. G02F 1/1335

(52) U.S. Cl. CPC G02F 1/133528

(57) ABSTRACT

Provided is a liquid crystal display device in which reflection and light leakage from oblique directions are reduced or prevented. The liquid crystal display device includes, sequentially in the following order from a back surface side: a first polarizer; a liquid crystal panel; a second polarizer; a first retardation layer; and a third polarizer, wherein light transmitted in an oblique direction between the second polarizer and the third polarizer is elliptically polarized light.

### CROSS-REFERENCE TO RELATED APPLICATIONS

The present application claims priority under 35 U.S.C. § 119 to Japanese Patent Application No. 2022-055724 filed on Mar. 30, 2022, the contents of which are incorporated herein by reference in their entirety.

### BACKGROUND OF THE INVENTION

### Field of the Invention

The present invention relates to liquid crystal display devices.

### Description of Related Art

Liquid crystal display devices typically include a liquid crystal panel, a backlight, and optical elements such as a polarizer. Such liquid crystal display devices are utilized in a wide variety of electronic devices such as smartphones, laptop computers, and in-vehicle displays, owing to their good display characteristics.

For enhancement of the viewability of liquid crystal display devices, a method of reducing the surface reflection of liquid crystal display devices have been studied. For example, JP 2011-252934 A discloses a display device comprising a display panel and a protective plate disposed facing the display panel, wherein the protective plate comprises a protective base material and a first polarizer, the display panel comprises a second polarizer of which a polarization axis is parallel to that of the first polarizer, and light passing between the first polarizer and the second polarizer is linearly polarized light.

### BRIEF SUMMARY OF THE INVENTION

While liquid crystal display devices are utilized in electronic devices such as smartphones, laptop computers, and in-vehicle displays, use of a liquid crystal display device in a bright environment may cause the black display of the device to appear grayish or whitish due to external light reflection. This may decrease the contrast ratio (CR) to reduce the viewability. The reduction in viewability due to external light reflection can occur not only in bright environments such as an outdoor environment where the illuminance is several thousand lux to several tens of thousands lux, but also in an indoor environment where the illuminance is about 500 lux.

Reflection by a liquid crystal display device can be roughly classified into surface reflection and internal reflection. Surface reflection can be reduced by placing an anti-reflection film, for example, on a surface of the liquid crystal display device. Internal reflection, however, cannot be reduced by an anti-reflection film because the reflection is caused by various metals, transparent electrodes, resists, and other components constituting the liquid crystal panel.

In addition, a liquid crystal panel in the liquid crystal display device, including polarizers having viewing angle dependency, may cause light leakage from a direction oblique to the normal direction of the liquid crystal panel in a black display state. The light leakage, especially when a dark image is displayed, may lead to a low contrast ratio (CR) which may cause a failure in making the black color appear black.

The conventional liquid crystal display device is more specifically described with reference to FIG. 19 and FIG. 20. FIG. 19 is a schematic cross-sectional view of an example of a liquid crystal display device of Comparative Embodiment 1. As shown in FIG. 19, a liquid crystal display device 100A of Comparative Embodiment 1 includes a backlight 140 and, sequentially from the backlight 140 side (back surface side), a reflective polarizer 114, a first polarizer 111, a liquid crystal panel 120, and a second polarizer 112. The first polarizer 111 and the second polarizer 112 are absorptive polarizers and arranged in crossed Nicols. The second polarizer 112 and the reflective polarizer 114 are arranged in parallel Nicols.

As shown by the solid-line arrow in FIG. 19, the liquid crystal display device 100A may exhibit low oblique direction viewability due to surface reflection and internal reflection of the liquid crystal display device. Also, as shown by the dashed-line arrow in FIG. 19, in observation from an oblique direction in a black display state, light emitted from the backlight 140 toward the liquid crystal panel 120 may be partially transmitted to the viewer side and observed as light leakage.

FIG. 20 is a schematic cross-sectional view of an example of a liquid crystal display device of Comparative Embodiment 2. As shown in FIG. 20, a liquid crystal display device 100B of Comparative Embodiment 2 further includes a first retardation layer 131 on the back surface side of the first polarizer 111. As shown by the dashed-line arrow, the liquid crystal display device 100B can more reduce light leakage due to transmission light from the backlight 140 than the liquid crystal display device 100A. This configuration, however, still leaves room for improvement in terms of reduction in surface reflection and internal reflection of the liquid crystal display device.

In response to the above issues, an object of the present invention is to provide a liquid crystal display device in which reflection and light leakage from oblique directions are reduced or prevented.
(1) One embodiment of the present invention is directed to a liquid crystal display device including, sequentially in the following order from a back surface side: a first polarizer; a liquid crystal panel; a second polarizer; a first retardation layer; and a third polarizer, wherein light transmitted in an oblique direction between the second polarizer and the third polarizer is elliptically polarized light.
(2) In an embodiment of the present invention, the liquid crystal display device includes the structure (1), and a transmittance of at least one of the second polarizer or the third polarizer is not lower than a transmittance of the first polarizer.
(3) In an embodiment of the present invention, the liquid crystal display device includes the structure (1) or (2), and a degree of polarization of at least one of the second polarizer or the third polarizer is not higher than a degree of polarization of the first polarizer.
(4) In an embodiment of the present invention, the liquid crystal display device includes any one of the structures (1) to (3), and the second polarizer and the third polarizer are different in transmittance or degree of polarization.
(5) In an embodiment of the present invention, the liquid crystal display device includes any one of the structures (1) to (4), the second polarizer and the third polarizer are linear polarizers, and a transmission axis of the second polarizer and a transmission axis of the third polarizer are parallel to each other.
(6) In an embodiment of the present invention, the liquid crystal display device includes the structure (5), a difference between a transmittance for light having passed through the second polarizer and the third polarizer and a transmittance of the first polarizer is not more than 1%, or a difference between a degree of polarization of light having passed through the second polarizer and the third polarizer and a degree of polarization induced by the first polarizer is not more than 1%.
(7) In an embodiment of the present invention, the liquid crystal display device includes any one of the structures (1) to (6), and the second polarizer is higher than the third polarizer in transmittance or degree of polarization.
(8) In an embodiment of the present invention, the liquid crystal display device includes any one of the structures (1) to (7), and further includes a second retardation layer between the second polarizer and the third polarizer.

The present invention can provide a liquid crystal display device in which reflection and light leakage from oblique directions are reduced or prevented.

### BRIEF DESCRIPTION OF THE DRAWINGS

FIG. 1 is a schematic cross-sectional view of an example of a liquid crystal display device of Embodiment 1.

FIG. 2 is a schematic cross-sectional view of another example of the liquid crystal display device of Embodiment 1.

FIG. 3 is a schematic cross-sectional view of an example of a liquid crystal display device of Embodiment 2.

FIG. 4 includes a contour plot showing the reflection viewing angle and a contour plot showing the transmission viewing angle in a black display state, both in a liquid crystal display device of Example 1.

FIG. 5 includes a contour plot showing the reflection viewing angle and a contour plot showing the transmission viewing angle in a black display state, both in a liquid crystal display device of Example 2.

FIG. 6 includes a contour plot showing the reflection viewing angle and a contour plot showing the transmission viewing angle in a black display state, both in a liquid crystal display device of Example 3.

FIG. 7 includes a contour plot showing the reflection viewing angle and a contour plot showing the transmission viewing angle in a black display state, both in a liquid crystal display device of Comparative Example 1.

FIG. 8 includes a contour plot showing the reflection viewing angle and a contour plot showing the transmission viewing angle in a black display state, both in a liquid crystal display device of Comparative Example 2.

FIG. 9 includes a contour plot showing the reflection viewing angle and a contour plot showing the transmission viewing angle in a black display state, both in a liquid crystal display device of Comparative Example 3.

FIG. 10 is a graph showing the measurement results of internal reflectance at a polar angle of 30° for light incident at various azimuthal angles, in liquid crystal display devices of Examples 2 and 3 and Comparative Examples 1 and 3.

FIG. 11 includes a contour plot showing the reflection viewing angle and a contour plot showing the transmission viewing angle in a black display state, both in a liquid crystal display device of Example 1-2.

FIG. 12 includes a contour plot showing the reflection viewing angle and a contour plot showing the transmission viewing angle in a black display state, both in a liquid crystal display device of Example 1-3.

FIG. 13 includes a contour plot showing the reflection viewing angle and a contour plot showing the transmission viewing angle in a black display state, both in a liquid crystal display device of Example 1-4.

FIG. 14 includes a contour plot showing the reflection viewing angle and a contour plot showing the transmission viewing angle in a black display state, both in a liquid crystal display device of Example 1-5.

FIG. 15 includes a contour plot showing the reflection viewing angle and a contour plot showing the transmission viewing angle in a black display state, both in a liquid crystal display device of Example 1-6.

FIG. 16 includes a contour plot showing the reflection viewing angle and a contour plot showing the transmission viewing angle in a black display state, both in a liquid crystal display device of Example 1-7.

FIG. 17 is a graph showing the measurement results of transmittance in a black display state at various polar angles in observation of the liquid crystal display devices of Examples 1-5 to 1-7 and Comparative Example 1 at an azimuthal angle of 45°.

FIG. 18 is a graph showing the measurement results of reflectance in a white display state at various polar angles in observation of the liquid crystal display devices of Examples 1-5 to 1-7 and Comparative Example 1 at an azimuthal angle of 45°.

FIG. 19 is a schematic cross-sectional view of an example of a liquid crystal display device of Comparative Embodiment 1.

FIG. 20 is a schematic cross-sectional view of an example of a liquid crystal display device of Comparative Embodiment 2.

### DETAILED DESCRIPTION OF THE INVENTION

### Definition of Terms

Herein, a “polarizer” means one having a function of filtering unpolarized light (natural light), partially polarized light, or polarized light into polarized light (linearly polarized light) vibrating only in a specific direction. Such a polarizer is distinctive from a circular polarizer. An “absorptive polarizer” means one having a function of absorbing light vibrating in a specific direction while transmitting polarized light (linearly polarized light) vibrating in a direction vertical to the specific direction. A “reflective polarizer” means one having a function of reflecting light vibrating in a specific direction while transmitting polarized light (linearly polarized light) vibrating in a direction vertical to the specific direction.

Herein, retardation R in the in-plane direction is defined by R=(ns−nf)d. Retardation Rth in the thickness direction is defined by Rth=(nz−(nx+ny)/2)d. An NZ factor (biaxial parameter) is defined by NZ=(ns−nz)/(ns −nf). In the equations, ns represents nx or ny, whichever is greater; nf represents nx or ny, whichever is smaller; nx and ny each represent a principal refractive index in the in-plane direction of a retardation layer; nz represents a principal refractive index in the out-of-plane direction, i.e., the direction vertical to a surface of the retardation layer; and d represents the thickness of the retardation layer.

The measurement wavelength for a principal refractive index, a retardation, an NZ factor, and other optical parameters herein is 550 nm, unless otherwise specified.

Herein, a “retardation layer” means one that provides a retardation R in the in-plane direction or a retardation Rth in the thickness direction in absolute value of not less than 10 nm, preferably not less than 20 nm.

The “viewer side” herein means the side closer to the screen (display surface) of the liquid crystal display device. The “back surface side” herein means the side farther from the screen (display surface) of the liquid crystal display device.

The “polar angle” herein means an angle formed by the normal direction, which is taken as 0°, of the screen of the liquid crystal panel and the direction in question (e.g., measurement direction, observation direction). The “azimuthal angle φ” herein means the direction in question in a view projected onto the screen of the liquid crystal panel and is expressed as an angle (azimuthal angle) formed with the reference azimuth. The reference azimuth (φ=0°) is set to the right in the horizontal direction of the screen of the liquid crystal panel. The azimuthal angle measures positive in the counterclockwise direction and measures negative in the clockwise direction. Both the counterclockwise and clockwise directions are rotational directions when the screen of the liquid crystal panel is viewed from the viewer side (front). The angle is a value measured in a plan view of the liquid crystal panel. The expression that two straight lines (including axes and directions) are “perpendicular” herein means that they are perpendicular in a plan view of the liquid crystal panel.

Herein, the expression that two straight lines (including axes and directions) are “parallel” or arranged “in parallel Nicols” means that they form an angle within the range of 0°±10°, preferably 0°±5°, more preferably 0°±1°. The expression that two straight lines (including axes and directions) are “perpendicular” or arranged “in crossed Nicols” herein means that they form an angle within the range of 90°±10°, preferably 90°±5°, more preferably 90°±1°.

The “axis azimuth” herein means, unless otherwise specified, the azimuth of the absorption axis (reflection axis) of a polarizer or the in-plane slow axis of a retardation layer.

Hereinafter, embodiments of the present invention are described. The present invention is not limited to the following embodiments. The design may be modified as appropriate within the range satisfying the configuration of the present invention.

### Embodiment 1

A liquid crystal display device of Embodiment 1 includes, sequentially in the following order from the back surface side, a first polarizer, a liquid crystal panel, a second polarizer, a first retardation layer, and a third polarizer. Light transmitted in an oblique direction between the second polarizer and the third polarizer is elliptically polarized light.

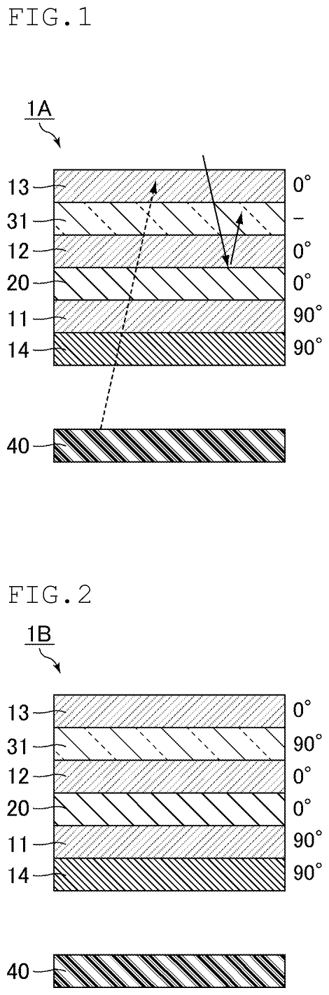

FIG. 1 is a schematic cross-sectional view of an example of the liquid crystal display device of Embodiment 1. The liquid crystal display device 1 of Embodiment 1 may be a transmissive liquid crystal display device, and may include, as shown in FIG. 1, a backlight 40 and, sequentially in the following order from the back surface side (backlight 40 side), a first polarizer 11, a liquid crystal panel 20, a second polarizer 12, a first retardation layer 31, and a third polarizer 13. The liquid crystal display device 1 may further include a fourth polarizer 14 on the backlight 40 side of the first polarizer 11. In FIG. 1, the solid-line arrow represents external light incident on the liquid crystal panel 20 from an oblique direction and reflection light reflected in the inside of the liquid crystal panel 20 and then emitted in an oblique direction. The dashed-line arrow represents light emitted from the backlight 40 toward the liquid crystal panel 20 in an oblique direction and transmitted through the liquid crystal panel 20.

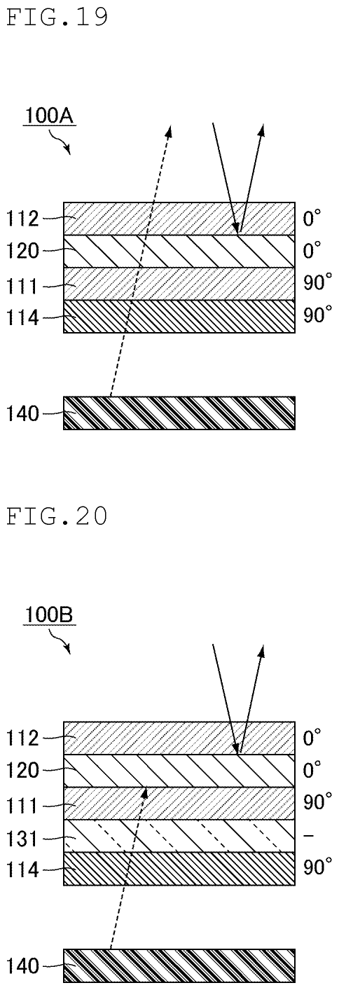

In FIG. 1 to FIG. 3, FIG. 19, and FIG. 20, the angle)(° at the right of each component represents an axis azimuth. For absorptive polarizers, the axis azimuth of the absorption axis is shown. For reflective polarizers, the axis azimuth of the reflection axis is shown. For retardation layers other than positive C plates or negative C plates, the axis azimuth of the in-plane slow axis is shown. For positive C plates and negative C plates, the symbol “—” is shown because their optic axis coincides with the normal direction and the in-plane slow axis is not defined. Hereinafter, positive C plates and negative C plates are simply referred to as “C plates” when no distinction is made therebetween.

The first retardation layer 31 between the second polarizer 12 and the third polarizer 13 converts light transmitted in an oblique direction between the second polarizer 12 and the third polarizer 13 to elliptically polarized light. At least light waves with a wavelength of 550 nm in the light transmitted in an oblique direction between the second polarizer 12 and the third polarizer 13 are converted to elliptically polarized light. At least one of light transmitted from the second polarizer 12 side to the third polarizer 13 side or light transmitted from the third polarizer 13 side to the second polarizer 12 side is converted to elliptically polarized light. Preferably, both of these lights are converted to elliptically polarized lights. The “oblique direction” means a direction other than the normal direction of the liquid crystal panel 20. Light transmitted between the second polarizer 12 and the third polarizer 13 is not necessarily converted to elliptically polarized light at all the oblique directions except for the normal direction of the liquid crystal panel 20; the light is converted to elliptically polarized light in at least one oblique direction.

The combination of the second polarizer 12, the first retardation layer 31, and the third polarizer 13 is also referred to as a polarizer louver hereinbelow because they act as an optical louver. The liquid crystal display device of Embodiment 1 includes a polarizer louver on the viewer side of the liquid crystal panel 20. Converting light transmitted between the second polarizer 12 and the third polarizer 13 to elliptically polarized light can reduce or prevent leakage of light transmitted in oblique directions from the backlight 40 side as shown by the dashed-line arrow in FIG. 1 in the black display state, thus increasing the contrast ratio (CR). Also, with the polarizer louver placed on the viewer side of the liquid crystal panel 20, the amount of external light can be reduced which is incident on the liquid crystal panel 20 from an oblique direction and reaches the inside of the liquid crystal panel 20. Consequently, as shown by the solid-line arrow in FIG. 1, the amount of reflection light can be reduced which is reflected in the inside of the liquid crystal panel 20 and emitted in an oblique direction. Thus, internal reflection of the liquid crystal panel 20 can be reduced or prevented.

The reflection light emitted in the normal direction after being incident from the normal direction usually poses no problem even when an external light source is present in the normal direction of the display because light from the light source is blocked by the viewer. When a light source is present between the viewer and the liquid crystal panel 20, reflection in the normal direction may be a problem. Yet, since this is a special case, reduction or prevention of reflection in oblique directions is sufficient in consideration of the actual use of the liquid crystal display device.

The first polarizer 11, the second polarizer 12, and the third polarizer 13 may be absorptive polarizers. An absorptive polarizer has a transmission axis and an absorption axis perpendicular to the transmission axis.

The absorptive polarizer may be, for example, an absorptive polarizer obtained by dyeing a polyvinyl alcohol (PVA) film with a dichroic anisotropic material such as an iodine complex to adsorb the anisotropic material on the PVA film and aligning the material. At least one surface of the PVA film may be laminated with a protective film such as a triacetyl cellulose (TAC) film for sufficient mechanical strength and sufficient moisture and heat resistance.

The first polarizer 11 and the second polarizer 12 hold the liquid crystal panel 20 in between. Preferably, the first polarizer 11, the second polarizer 12, and the third polarizer 13 are linear polarizers. The first polarizer 11 and the second polarizer 12 may be arranged in crossed Nicols. In other words, the transmission axis of the first polarizer 11 and the transmission axis of the second polarizer 12 may be perpendicular to each other.

Although the first polarizer 11 and the second polarizer 12 may also be arranged in parallel Nicols, they are preferably arranged in crossed Nicols for a high contrast ratio.

Preferably, the transmission axis of the second polarizer 12 and the transmission axis of the third polarizer 13 are parallel to each other. This arrangement enables bright display in a white display state in the normal direction and the top, bottom, left, and right directions of the liquid crystal panel 20.

The second polarizer 12 and the third polarizer 13 are not necessarily higher than the first polarizer 11 in performance. As long as the performance demonstrated by the second polarizer 12 and the third polarizer 13 in combination is equivalent to the performance of the first polarizer 11, the above configuration can prevent a decrease in transmittance of the liquid crystal display device 1A in a white display state as compared to a configuration without the third polarizer 13, while preventing a decrease in contrast ratio as compared to a configuration without the third polarizer 13.

The transmission axis of the second polarizer 12 and the transmission axis of the third polarizer 13 may be parallel to each other, and the difference between the transmittance for light transmitted through the second polarizer 12 and the third polarizer 13 and the transmittance of the first polarizer 11 may be not more than 1%, or the difference between the degree of polarization of light transmitted through the second polarizer 12 and the third polarizer 13 and the degree of polarization induced by the first polarizer 11 may be not more than 1%. Herein, the transmittance of a polarizer means the transmittance for light with a wavelength of 550 nm, and refers to the later-described single transmittance Ts unless otherwise specified.

For prevention of a decrease in transmittance of the liquid crystal display device 1A in a white display state as compared to a configuration without the third polarizer 13, the transmittance of at least one of the second polarizer 12 or the third polarizer 13 may be not lower than the transmittance of the first polarizer 11. With the transmittance of at least one of the second polarizer 12 or the third polarizer 13 not lower than the transmittance of the first polarizer 11, the present configuration can prevent a decrease in transmittance of the liquid crystal display device 1A in a white display state as compared to a configuration without the third polarizer 13.

The degree of polarization induced by at least one of the second polarizer 12 or the third polarizer 13 may be not higher than the degree of polarization induced by the first polarizer 11. Typically, there is a trade-off relationship between the transmittance of a polarizer and the degree of polarization induced by the polarizer. Specifically, the higher the transmittance of a polarizer, the lower the degree of polarization induced by the polarizer, while the lower the transmittance of a polarizer, the higher the degree of polarization. Thus, the above configuration can prevent a decrease in transmittance of the liquid crystal display device 1A in a white display state as compared to a configuration without the third polarizer 13. Herein, the degree of polarization induced by a polarizer means the extent to which light with a wavelength of 550 nm is polarized by the polarizer.

The degree of polarization induced by a polarizer is a measure of polarization function showing the extent to which natural light incident on the polarizer is polarized after passing through the polarizer. The degree of polarization induced by a polarizer is expressed using a contrast ratio variable. Let C=Tp/Tc and P=Sqrt((Tp−Tc)/(Tp+Tc)) be the given equations, wherein Tp represents the parallel Nicols transmittance (parallel transmittance) of the polarizers, Tc represents the crossed Nicols transmittance (perpendicular transmittance) of the polarizers, P represents the degree of polarization induced by the polarizer, and C represents the contrast ratio provided by the polarizers. These equations are transformable into the equation P=Sqrt((CR−1)/(CR+1)) or C=(1+P\hat{ }2)/(1−P\hat{ }2), wherein Sqrt represents the square root symbol and −2 represents the squared symbol.

The transmittance of a polarizer determined when the azimuth at which ideal linearly polarized light incident on the polarizer vibrates coincides with the transmission axis of the polarizer is referred to as first principal transmittance k1. The transmittance of the polarizer determined when the azimuth at which the ideal linearly polarized light incident on the polarizer vibrates is perpendicular to the transmission axis is referred to as second principal transmittance k2. The transmittance of a single polarizer when unpolarized light is incident on the polarizer is referred to as single transmittance Ts. The transmittance of a stack of the same two polarizers in parallel Nicols when unpolarized light is incident on the stack is referred to as parallel Nicols transmittance Tp. The transmittance of a stack of the same two polarizers in crossed Nicols when unpolarized light is incident on the stack is referred to as crossed Nicols transmittance Tc. Unpolarized light with an intensity of 1 can be regarded as the sum of linearly polarized light with an intensity of ½ vibrating in a direction A and linearly polarized light with an intensity of ½ vibrating in a direction perpendicular to the direction A. Then, Ts, Tp, and Tc can be represented by the following respective equations using k1 and k2.

Ts=(½)×k1+(½)×k2=(½)×(k1+k2)

Tp=(½)×k1×k1+(½)×k2×k2=(½)×(k1\hat{ }2+k2\hat{ }2)

Tc=(½)×k1×k2+(½)×k2×k1=(½)×(2k1×k2)

The second polarizer 12 and the third polarizer 13 may be different in performance. In other words, the third polarizer 13 and the second polarizer 12 may be different in transmittance or degree of polarization. When the second polarizer 12 and the first polarizer 11 are arranged in crossed Nicols, the second polarizer 12 and the first polarizer 11 collaboratively determine the transmissive display performance. Thus, the second polarizer 12 preferably exhibits performance as high as possible. The second polarizer 12 is preferably higher than the third polarizer 13 in performance. As described above, typically, there is a trade-off relationship between the transmittance of a polarizer and the degree of polarization induced by the polarizer. Thus, in other words, the second polarizer 12 is preferably higher than the third polarizer 13 in transmittance or degree of polarization.

In terms of the anti-reflection performance, the second polarizer 12 may be equivalent to the third polarizer 13 in performance. When the second polarizer 12 and the third polarizer 13 are arranged in parallel Nicols, the second polarizer 12 and the third polarizer 13 collaboratively achieve the louver effect to determine the anti-reflection performance of the display device. This means that the anti-reflection performance does not change as long as the second polarizer 12 and the third polarizer 13, even when one of them is higher than the other in performance or vice versa, collaboratively exhibit a performance equivalent to the performance exhibited by a hypothetically single polarizer defined by the second polarizer 12 and the third polarizer 13. In other words, the performance distribution between the second polarizer 12 and the third polarizer 13 is rather not important. The difference between the transmittance of the second polarizer 12 and the transmittance of the third polarizer 13 may be not more than 1% or the difference between the degree of polarization induced by the second polarizer 12 and the degree of polarization induced by the third polarizer 13 may be not more than 1%.

When the second polarizer 12 and the third polarizer 13 are regarded as constituting a single polarizer, the parallel Nicols transmittance Tp and the crossed Nicols transmittance Tc of the single polarizer constituted by the second polarizer 12 and the third polarizer 13 can be calculated from the following equations, given that the first principal transmittance of the second polarizer 12 is k1, the second principal transmittance of the second polarizer 12 is k2, the first principal transmittance of the third polarizer 13 is k1′, and the second principal transmittance of the third polarizer 13 is k2′. The difference between the parallel Nicols transmittance Tp of the single polarizer constituted by the second polarizer 12 and the third polarizer 13 and the transmittance of the first polarizer 11 may be not more than 1%. Also, the difference between the degree of polarization induced by the single polarizer constituted by the second polarizer 12 and the third polarizer 13 calculated using the following Tp and Tc and the degree of polarization induced by the first polarizer 11 may be not more than 1%.

Tp=(½)×k1×k1′+(½)×k2×k2′=(½)×(k1×k1′+k2×k2′)

Tc=(½)×k1×k2′+(½)×k2×k1′=(½)×(k1×k2′+k2×k1′)

The first retardation layer 31 is placed between the second polarizer 12 and the third polarizer 13. The first retardation layer 31 may be any retardation layer that can convert light transmitted in an oblique direction between the second polarizer 12 and the third polarizer 13 to elliptically polarized light. The retardation R in the in-plane direction introduced by the first retardation layer 31 is preferably not less than 250 nm and not more than 310 nm.

The retardation Rth in the thickness direction introduced by the first retardation layer 31 may be: (1) less than 400 nm (suitably not more than 300 nm); or (2) not less than 400 nm (suitably not less than 500 nm). In the condition (1), the retardation Rth in the thickness direction introduced by the first retardation layer 31 is preferably not less than 120 nm, more preferably not less than 140 nm. In the condition (2), the retardation Rth in the thickness direction introduced by the first retardation layer 31 is preferably not more than 610 nm.

The total retardation Rth in the thickness direction introduced between the second polarizer 12 and the third polarizer 13 in absolute value may satisfy the condition (1) or (2). Herein, the total retardation Rth in the thickness direction introduced between the second polarizer 12 and the third polarizer 13 means the sum of all the retardations Rth in the thickness direction introduced by layers (films) placed between the second polarizer 12 and the third polarizer 13.

The biaxial parameter NZ of the first retardation layer 31 may satisfy: (I) 0.9≤NZ<10 (suitably, 1.5≤NZ<5.0); (II) 10≤NZ (suitably, 100≤NZ); (III)−11<NZ≤−0.9; or (IV) NZ≤−11 (suitably, NZ≤−100).

In the condition (I), the in-plane slow axis of the first retardation layer 31 may be: (I-1) parallel to the transmission axis of the second polarizer 12 or the transmission axis of the third polarizer 13; or (I-2) perpendicular to the transmission axis of the second polarizer 12 or the transmission axis of the third polarizer 13. The slow axis in observation from an oblique direction depends on the observation angle and the NZ factor. The retardation in observation from an oblique direction depends on the observation angle, the NZ factor, and the retardation R in the in-plane direction (or the retardation Rth in the thickness direction). When the angle formed by the slow axis of the first retardation layer 31 and the absorption axis of the second polarizer 12 is either 0° or 90°, increasing the NZ factor makes the first retardation layer 31 act more like a negative C plate, and act completely as a negative C plate in the limit of 1«NZ (NZ→+∞). Conversely, decreasing the NZ factor makes the first retardation layer 31 act more like a positive C plate.

In the condition (II), the upper limit of the biaxial parameter NZ of the first retardation layer 31 is not limited and may be +∞. In this case, the first retardation layer 31 acts as a negative C plate.

In the condition (IV), the lower limit of the biaxial parameter NZ of the first retardation layer 31 is not limited and may be −∞. In this case, the first retardation layer 31 acts as a positive C plate.

In the conditions (II) and (IV), the first retardation layer 31 introduces a sufficiently small retardation R in the in-plane direction and can thus be considered substantially optically isotropic in the plane. Thus, axes of the first retardation layer 31 may be placed in any direction in the plane.

FIG. 1 shows an example where the first retardation layer 31 is a negative C plate or a positive C plate. As described above, when the first retardation layer 31 is a negative C plate or a positive C plate, axes of the first retardation layer 31 may be placed in any direction in the plane.

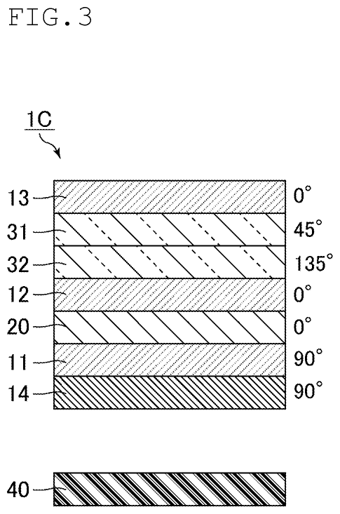

FIG. 2 is a schematic cross-sectional view of another example of the liquid crystal display device of Embodiment 1. FIG. 2 shows as an example of a liquid crystal display device 1B corresponding to a case where the first retardation layer 31 is a layer other than a negative C plate or a positive C plate, and the in-plane slow axis of the first retardation layer 31 is perpendicular to the transmission axis of the second polarizer 12 or the transmission axis of the third polarizer 13 (the above condition (I-2)).

The first retardation layer 31 may be formed from any material. For example, a stretched polymer film, a film made of a liquid crystalline material whose alignment is fixed, or a thin plate made of an inorganic material can be used.

Each retardation layer may be formed by any method. When the retardation layer is formed from a polymer film, for example, a method such as solvent casting or melt extrusion can be used. Also, co-extrusion may be used to form a plurality of retardation layers simultaneously. The polymer film may or may not be stretched as long as the desired retardation is introduced. The stretching method may be any method such as tensile stretching between rolls, compression stretching between rolls, tenter transverse uniaxial stretching, oblique stretching, vertical and transverse biaxial stretching, or special stretching where a film is stretched under the shrinkage stress of a heat shrinkable film. When the retardation layer is formed from a liquid crystalline material, for example, a method can be used such as a method of applying a liquid crystalline material to a base film having undergone an alignment treatment and fixing the alignment of the material. The method may be one including no special alignment treatment on a base film or one including removing the liquid crystalline material from the base material after the alignment fixation and transferring the material to another film, as long as the desired retardation is introduced. A method may also be used which includes no fixation of the alignment of a liquid crystalline material. When the retardation layer is formed from a non-liquid crystalline material, the same formation method as when the retardation layer is formed from a liquid crystalline material may be used.

The first retardation layer 31 satisfying the relationship 0.9≤NZ<10 can appropriately be, for example, a stretched film containing a material with a positive intrinsic birefringence as its component. Examples of the material with a positive intrinsic birefringence include polycarbonate, polysulfone, polyethersulfone, polyethylene terephthalate, polyethylene, polyvinyl alcohol, norbornene, triacetyl cellulose, or diacetyl cellulose.

The first retardation layer 31 satisfying the relationship 10≤NZ can appropriately be, for example, what is called a negative C plate. The negative C plate can appropriately be, for example, a film containing a material with a positive intrinsic birefringence as its component and having been subjected to vertical and transverse biaxial stretching, a film to which a liquid crystalline material such as a cholesteric (chiral nematic) liquid crystal or a discotic liquid crystal has been applied, or a film to which a non-liquid crystalline material such as polyimide or polyamide has been applied.

The first retardation layer 31 satisfying the relationship −11<NZ≤−0.9 can appropriately be, for example, a stretched film containing a material with a negative intrinsic birefringence as its component or a film containing a material with a positive intrinsic birefringence as its component and having been stretched under the shrinkage stress of a heat shrinkable film. In particular, for simplification of the production method, a stretched film containing a material with a negative intrinsic birefringence as its component is preferred. Examples of the material with a negative intrinsic birefringence include resin compositions such as acrylic resin and styrene resin, polystyrene, polyvinyl naphthalene, polyvinyl biphenyl, polyvinyl pyridine, polymethyl methacrylate, polymethyl acrylate, N-substituted maleimide copolymers, polycarbonate having a fluorene skeleton, and triacetyl cellulose (in particular, one with low degree of acetylation).

The first retardation layer 31 satisfying the relationship NZ≤−11 can appropriately be, for example, what is called a positive C plate. The positive C plate can appropriately be, for example, a film containing a material with a negative intrinsic birefringence as its component and having been subjected to vertical and transverse biaxial stretching, or a film to which a liquid crystalline material such as nematic liquid crystal has been applied.

The fourth polarizer 14 is preferably a linear polarizer, and may be a reflective polarizer. A reflective polarizer has a transmission axis and a reflection axis perpendicular to the transmission axis. A reflective polarizer has an effect of recycling backlight illumination. Thus, with a reflective polarizer placed on the back surface side of the first polarizer 11, the transmittance of the liquid crystal display device 1A in a white display state can be increased.

When the first polarizer 11 is an absorptive polarizer and the fourth polarizer 14 is a reflective polarizer, the axis azimuth of the absorption axis of the first polarizer 11 and the axis azimuth of the reflection axis of the fourth polarizer 14 may be perpendicular or parallel to each other.

Examples of the reflective polarizer include reflective polarizers obtained by uniaxially stretching a co-extruded film made of two types of resins (e.g., APCF available from Nitto Denko Corporation, DBEF available from 3M Company), and reflective polarizers including periodic arrays of metal thin lines (wire grid polarizers).

The liquid crystal panel 20 may be in any liquid crystal mode, such as a mode of providing black display by aligning the liquid crystal molecules in the liquid crystal layer vertically to a substrate surface, or a mode of providing black display by aligning the liquid crystal molecules in the liquid crystal layer parallelly to or in a direction that is not vertical or parallel to a substrate surface. The liquid crystal panel 20 may be driven by the TFT method (active matrix method), the simple matrix method (passive matrix method), or the plasma address method.

The liquid crystal panel 20 may be a liquid crystal panel in which a liquid crystal layer is sandwiched between paired substrates one of which includes pixel electrodes and a common electrode, and voltage is applied between the pixel electrodes and the common electrode to generate a transverse electric field (including a fringe electric field) in the liquid crystal layer. The liquid crystal panel 20 may also be a liquid crystal panel in which a liquid crystal layer is sandwiched between paired substrates one of which includes pixel electrodes and the other of which includes a common electrode, and voltage is applied between the pixel electrodes and the common electrode to generate a vertical electric field in the liquid crystal layer.

Specifically, examples of the transverse electric field mode include the fringe field switching (FFS) mode and the in plane switching (IPS) mode which align the liquid crystal molecules in the liquid crystal layer parallelly to a substrate surface with no voltage applied. Examples of the vertical electric field mode include the vertical alignment (VA) mode which aligns the liquid crystal molecules in the liquid crystal layer vertically to a substrate surface with no voltage applied.

Circular polarizers have been known to reduce internal reflection. However, circular polarizers cannot achieve anti-reflection in principle in the transverse electric field modes (FFS mode, IPS mode). In contrast, the light-shielding louver in the present embodiment is suitable as an anti-reflection device for the FFS mode and the IPS mode.

The backlight 40 may be any backlight commonly used in the field of liquid crystal display devices, and may be a direct-lit backlight including light sources coinciding with the display region of the liquid crystal panel 20, or an edge-lit backlight including a light guide plate and light sources along an end of the light guide plate.

### Embodiment 2

A liquid crystal display device of Embodiment 2 includes retardation layers between the second polarizer 12 and the third polarizer 13. In the present embodiment, components having the same or similar functions in the present embodiment and Embodiment 1 are commonly provided with the same reference sign so as to appropriately avoid repetition of description.

FIG. 3 is a schematic cross-sectional view of an example of a liquid crystal display device of Embodiment 2. As shown in FIG. 3, a liquid crystal display device 1C of Embodiment 2 further includes a second retardation layer 32 between the second polarizer 12 and the third polarizer 13. In Embodiment 2, the combination of the second polarizer 12, the first retardation layer 31, the second retardation layer 32, and the third polarizer 13 is also referred to as a polarizer louver.

The second retardation layer 32 can be any retardation layer mentioned as an example of the first retardation layer 31. The retardation R in the in-plane direction introduced by the second retardation layer 32 is preferably not less than 250 nm and not more than 310 nm.

As with the first retardation layer 31, the retardation Rth in the thickness direction introduced by the second retardation layer 32 may be: (1) less than 400 nm (suitably, not more than 300 nm); or (2) not less than 400 nm (suitably, not less than 500 nm). In the condition (1), the retardation Rth in the thickness direction introduced by the second retardation layer 32 is preferably not less than 120 nm, more preferably not less than 140 nm. In the condition (2), the retardation Rth in the thickness direction introduced by the second retardation layer 32 is preferably not more than 610 nm.

The total retardation Rth in absolute value in the thickness direction introduced between the second polarizer 12 and the third polarizer 13 may satisfy the condition (1) or (2), preferably the condition (2).

As with the first retardation layer 31, the biaxial parameter NZ of the second retardation layer 32 may satisfy: (I) 0.9≤NZ<10 (suitably, 1.5≤NZ<5.0); (II) 10≤NZ (suitably, 100≤NZ); (III)−11<NZ≤−0.9; or (IV) NZ≤−11 (suitably, NZ≤−100). In the condition (I), the in-plane slow axis of the second retardation layer 32 may be: (I-1) parallel to the transmission axis of the second polarizer 12 or the transmission axis of the third polarizer 13; or (I-2) perpendicular to the transmission axis of the second polarizer 12 or the transmission axis of the third polarizer 13.

The first retardation layer 31 and the second retardation layer 32 are preferably substantially the same as each other (layers formed from substantially the same material through substantially the same process and exhibiting substantially the same characteristics). With the first retardation layer 31 and the second retardation layer 32 being substantially the same as each other, the production cost can be lowered. From the technical aspects, use of retardation layers that are substantially the same as each other leads to less or no variation in production. Especially the later-described condition (I-3) can be expected to leave no residual retardation as a result of complete cancellation of the retardation R in the in-plane direction.

The first retardation layer 31 and the second retardation layer 32 may each have a biaxial parameter NZ satisfying one of the conditions (I) to (IV). The first retardation layer 31 and the second retardation layer 32 may have a biaxial parameter NZ satisfying the condition (I).

When the first retardation layer 31 and the second retardation layer 32 satisfy the condition (I), the in-plane slow axes of the first retardation layer 31 and the second retardation layer 32 may be in the same arrangement relationship with the transmission axis of the second polarizer 12. In other words, the in-plane slow axes of the first retardation layer 31 and the second retardation layer 32 may both be parallel to the transmission axis of the second polarizer 12 (the condition (I-1)) or perpendicular to the transmission axis of the second polarizer 12 (the condition (I-2)).

When the first retardation layer 31 and the second retardation layer 32 satisfy the condition (I), the retardation layers may satisfy the following condition (I-3): the angle formed by the in-plane slow axis of the first retardation layer 31 and one of the transmission axis of the second polarizer 12 and the transmission axis of the third polarizer 13 is not smaller than 30° and not greater than 60° (suitably not smaller than 40° and not greater than 50°, more suitably not smaller than 43° and not greater than 47°, still more suitably substantially 45°).

When two or more retardation layers are placed and two or more of them satisfy the condition (I-3), the in-plane slow axis of the retardation layers are preferably perpendicular to one another. When there is an even number (2n, where n is a natural number) of retardation layers, first n retardation layers and second n retardation layers are preferably arranged with the in-plane slow axes of the first n retardation layers being perpendicular to the in-plane slow axes of the second n retardation layers. When there is an even number of retardation layers and the number is four or greater, the retardation layers may be stacked in any order. For example, the in-plane slow axes sequentially from the viewer side may be respectively arranged at azimuthal angles of 45°/135°/45°/135°, azimuthal angles of 45°/45°/135°/135°, or azimuthal angles of 45°/135°/135°/45°. In all of these cases, the same effect can be achieved.

When there is an odd number of retardation layers, the in-plane slow axes are preferably arranged such that the retardation layers introduce a total in-plane retardation of zero, for reduction or elimination of influence in the front direction. For example, when there are three retardation layers, the in-plane slow axis of the first retardation layer may be at an azimuthal angle of 45°, the in-plane slow axis of the second retardation layer (introducing an in-plane retardation that is twice the in-plane retardation of the first retardation layer) may be at an azimuthal angle of 135°, and the in-plane slow axis of the third retardation layer (introducing the same in-plane retardation as the in-plane retardation of the first retardation layer) may be at an azimuthal angle of 45°.

### EXAMPLES

Hereinafter, the present invention is described in more detail with reference to examples and comparative examples. The present invention is not limited to these examples.

Table 1 summarizes the transmittances T (%) and the degrees of polarization (%) of polarizers A to D used in the following examples and comparative examples. The polarizers A to D were absorptive polarizers each obtained by dying a polyvinyl alcohol (PVA) film with a dichroic iodine complex to adsorb the iodine complex on the PVA film and aligning the iodine complex.

### (Method of Measuring Transmittance and Degree of Polarization of Polarizer)

The transmittances T (%) and the degrees of polarization (%) of the polarizers A to D were measured by the following procedure with a UV-visible spectrophotometer (available from JASCO Corporation, product name: V-7100). A Glan-Thompson prism, a Glan-Taylor prism, or another ideal polarizer available as an optional instrument of the measurement equipment was used to convert the measurement light (light incident on a polarizer specimen) to linearly polarized light. The spectral transmittance in the visible wavelength range (wavelengths from 380 nm to 780 nm) was measured, with which the Y value, corresponding to the transmittance T, was then calculated through luminosity correction with the 2-degree field of view (C illuminant) in conformity with JIS Z8701-1982.

TABLE 1

| Type of | T | Degree of |
|---|---|---|
| polarizer | (%) | polarization (%) |
| A | 42.2 | 99.996 |
| B | 43.8 | 99.692 |
| C | 44.3 | 99.098 |
| D | 45.1 | 97.372 |

### (Methods of Measuring R, Rth, NZ Factor, nx, ny, and nz)

The retardation R in the in-plane direction, the retardation Rth in the thickness direction, and the NZ factor of each of the first retardation layer 31 and the second retardation layer 32 shown in Table 2 and Table 3 were measured by the following procedures with a dual rotating retarder polarimeter (available from Axometrics, Inc., product name: Axo-scan). The retardation R in the in-plane direction was actually measured from the normal direction of the retardation layer. The principal refractive indices nx, ny, and nz, the retardation Rth in the thickness direction, and the NZ factor were calculated by a known curve fitting method using a refractive index ellipsoid and measured retardations. The retardations were measured in the normal direction of the retardation layer and in oblique directions inclined from the normal direction by angles ranging from −50° to 50°. The azimuths of the inclination were perpendicular to the in-plane slow axis. Although the nx, ny, nz, Rth, and NZ depend on the average refractive index represented by the formula (nx+ny+nz)/3 which is given as a calculation condition for curve fitting, the average refractive index of each retardation layer was set to 1.5 in calculation. For a retardation layer having an actual average refractive index different from 1.5, an average refractive index of 1.5 was used in calculation.

### Example 1

Example 1 is a specific example of the display device of Embodiment 1 and the configuration thereof is the same as shown in FIG. 1. FIG. 1 is also a schematic cross-sectional view of a liquid crystal display device of Example 1. As shown in FIG. 1, the liquid crystal display device of Example 1 includes the backlight 40 and, sequentially in the following order from the backlight 40 side (back surface side), the reflective polarizer 14, the first polarizer 11, the liquid crystal panel 20, the second polarizer 12, the first retardation layer 31, and the third polarizer 13. The liquid crystal panel 20 was an FFS-mode liquid crystal panel operated in a transverse electric field mode. The reflective polarizer 14 was the reflective polarizer APF available from 3M Company.

In Example 1, as shown in Table 2, the first, second, and third polarizers were the polarizers A shown in Table 1. The first retardation layer was a negative C plate introducing a retardation Rth in the thickness direction of 250 nm. The retardation R in the in-plane direction and the retardation Rth in the thickness direction introduced by the first retardation layer in Example 1 are as shown in Table 2. In Table 2 and Table 3 below, the retardation R introduced by a retardation layer other than a C plate is an in-plane retardation. Since the in-plane retardation introduced by a C plate is 0, the retardation Rth in the thickness direction is shown for a C plate.

### Example 2

Example 2 is another specific example of the display device of Embodiment 1 and the configuration thereof is the same as shown in FIG. 2. FIG. 2 is also a schematic cross-sectional view of the liquid crystal display device of Example 2. In Example 2, the first retardation layer 31 was a retardation layer other than a C plate, and the in-plane slow axis was placed as shown in FIG. 2. The retardation R in the in-plane direction, the retardation Rth in the thickness direction, and the NZ factor of the first retardation layer 31 in Example 2 are as shown in Table 2.

### Example 3

Example 3 is a specific example of the display device of Embodiment 2 and the configuration thereof is the same as shown in FIG. 3. FIG. 3 is also a schematic cross-sectional view of a liquid crystal display device of Example 3. In Example 3, the retardation layer had a two-layer structure with the first retardation layer 31 and the second retardation layer 32 being the retardation layers used in Example 2. The in-plane slow axes of the first retardation layer 31 and the second retardation layer 32 were placed as shown in FIG. 3.

### Comparative Example 1

Comparative Example 1 is another specific example of the display device of Comparative Embodiment 1 and the configuration thereof is the same as shown in FIG. 19. FIG. 19 is also a schematic cross-sectional view of a liquid crystal display device of Comparative Example 1. The liquid crystal display device of Comparative Example 1 includes the backlight 140 and, sequentially in the following order from the backlight 140 side (back surface side), the reflective polarizer 114, the first polarizer 111, the liquid crystal panel 120, and the second polarizer 112. The backlight 140, the liquid crystal panel 120, and the reflective polarizer 114 were the same as in Example 1.

### Comparative Example 2

Comparative Example 2 is another specific example of the display device of Comparative Embodiment 2 and the configuration thereof is the same as shown in FIG. 20. FIG. 20 is also a schematic cross-sectional view of a liquid crystal display device of Comparative Example 2. The liquid crystal display device of Comparative Example 2 includes the backlight 140 and, sequentially in the following order from the backlight 140 side (back surface side), the reflective polarizer 114, the first retardation layer 131, the first polarizer 111, the liquid crystal panel 120, and the second polarizer 112. The first retardation layer 131 was the negative C plate which was the same as in Example 1. The backlight 140, the liquid crystal panel 120, and the reflective polarizer 114 were the same as in Example 1.

### Comparative Example 3

A liquid crystal display device of Comparative Example 3 has the same configuration as in Comparative Example 2, except that the first retardation layer 131 was the same as in Example 2 and the axis azimuth was set to 0°.

### (Viewing Angle Characteristics)

The reflection viewing angle and the transmission viewing angle were calculated as the viewing angle characteristics of each of the liquid crystal display devices of Examples 1 to 3 and Comparative Examples 1 to 3. In calculation, the surface reflectance of the liquid crystal panel was simply replaced with the reflectance of an ideal mirror (reflectance: 100%). The reflection viewing angle and the transmission viewing angle were calculated with a liquid crystal optical simulator (available from Shintech Inc., product name: LCD-MASTER).

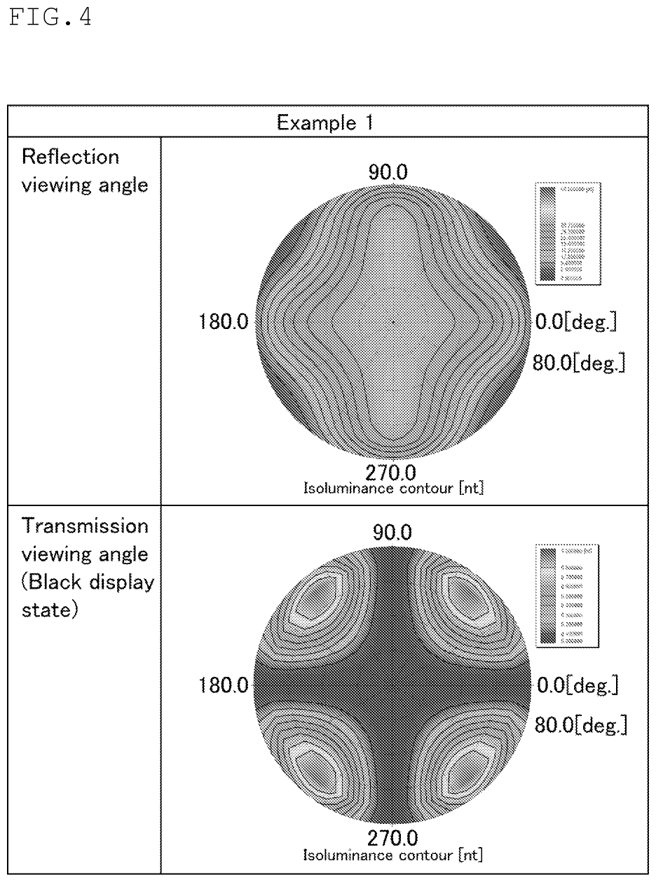

For the reflection viewing angle, the reflectances of the liquid crystal display device at polar angles of 0° to 80° were calculated with the azimuthal angle in a white display state varied from 0° to 360°. For the transmission viewing angle, the transmittances of the liquid crystal display device at polar angles of 0° to 80° were calculated with the azimuthal angle in a black display state varied from 0° to 360°. FIG. 4 to FIG. 9 show the results of viewing angle characteristics. FIG. 4 to FIG. 9 respectively show the results of the liquid crystal display devices of Examples 1 to 3 and Comparative Examples 1 to 3, each including a contour plot showing the reflection viewing angle and a contour plot showing the transmission viewing angle in the black display state. A contour plot shows the brightness levels where a higher value indicates a higher transmittance or higher reflectance. A portion with a high value in a contour plot showing the reflection viewing angle indicates that the reflectance of the liquid crystal panel including the internal reflection and the external reflection is high. A portion with a high value in a contour plot showing the transmission viewing angle indicates occurrence of light leakage in the black display state. The white display state means a state where the luminance of the liquid crystal display device is highest, while the black display state means a state where the luminance of the liquid crystal display device is lowest. The backlight was kept turned on in the black display state as well.

### (Front Transmittance in White Display State)

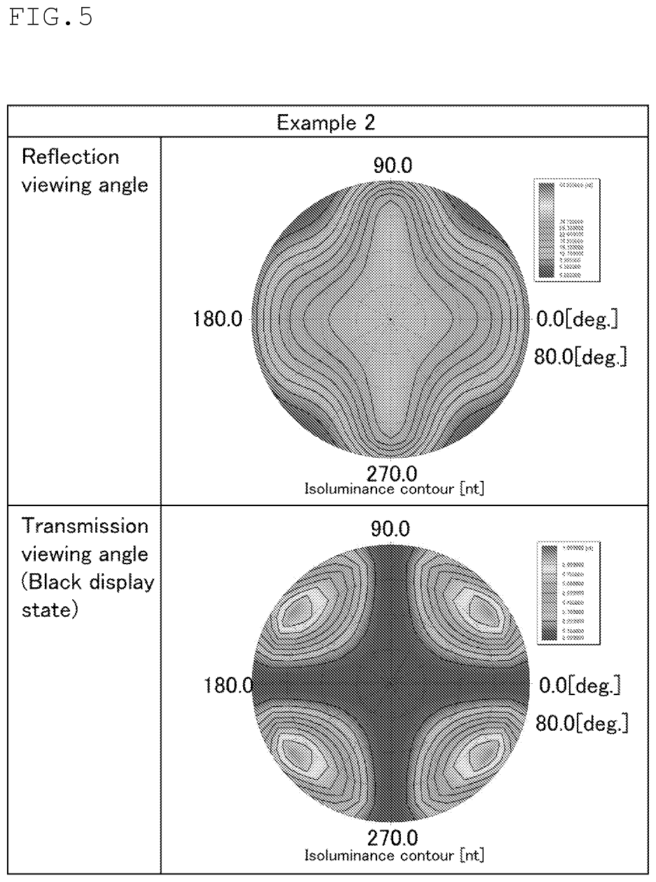

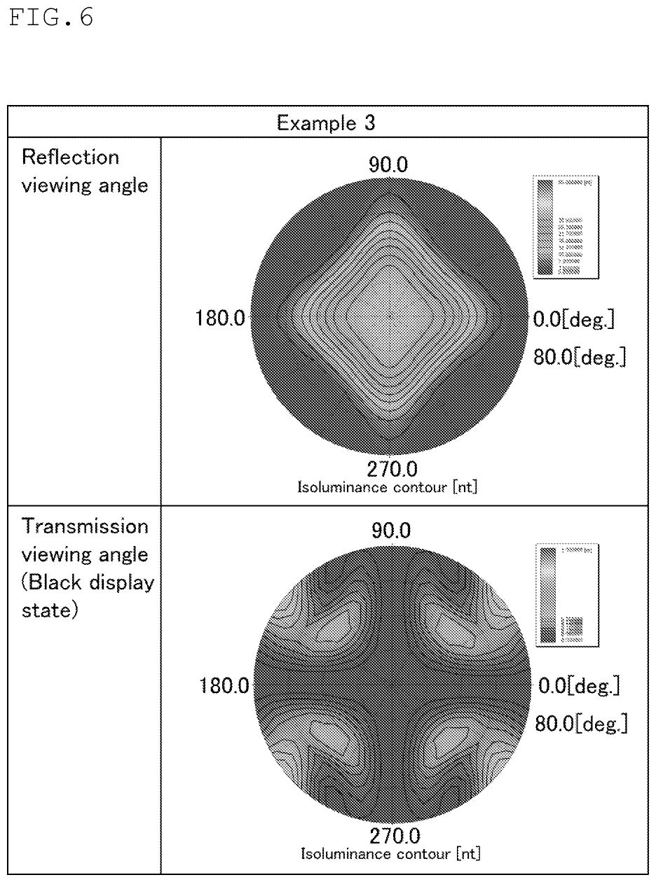

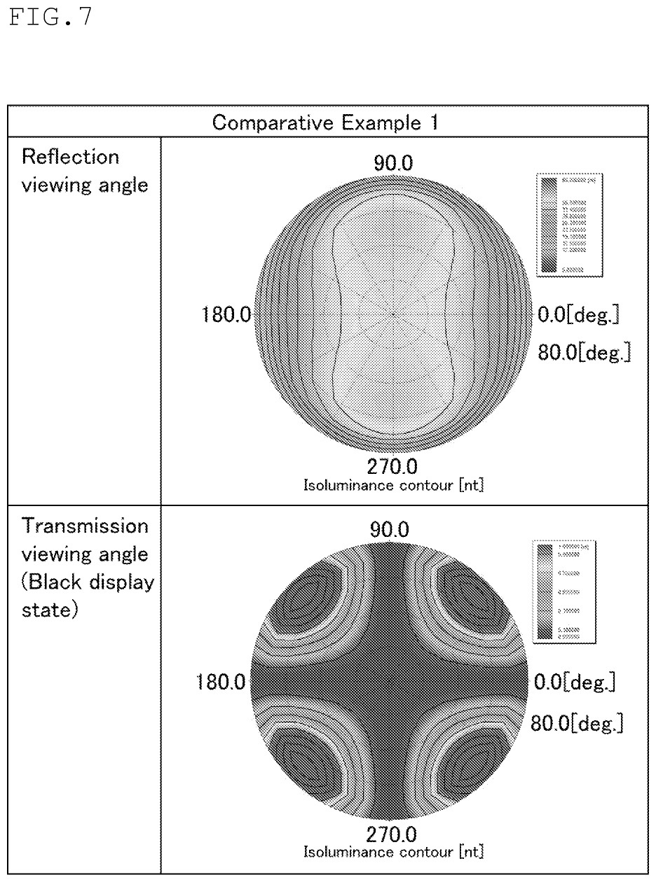

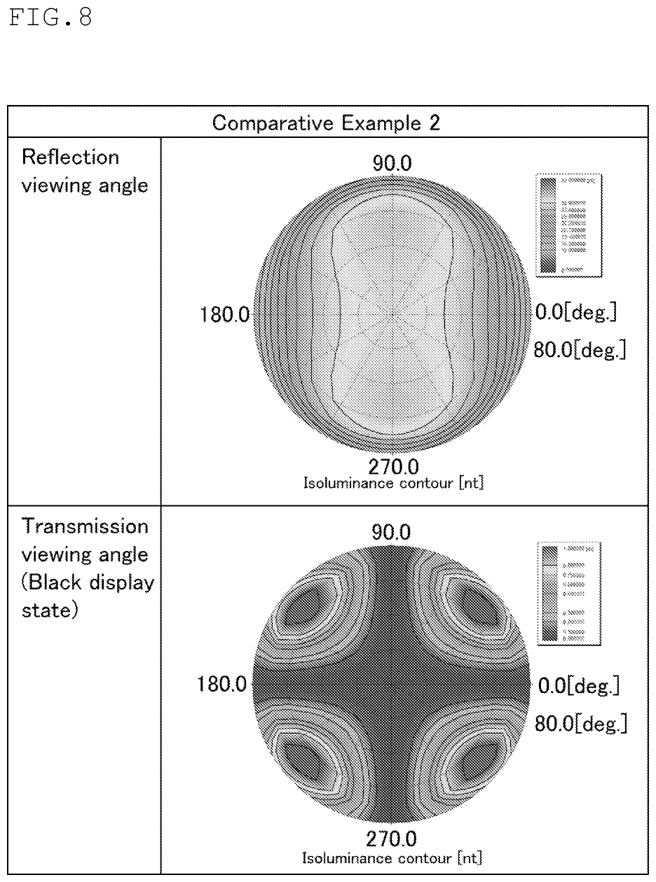

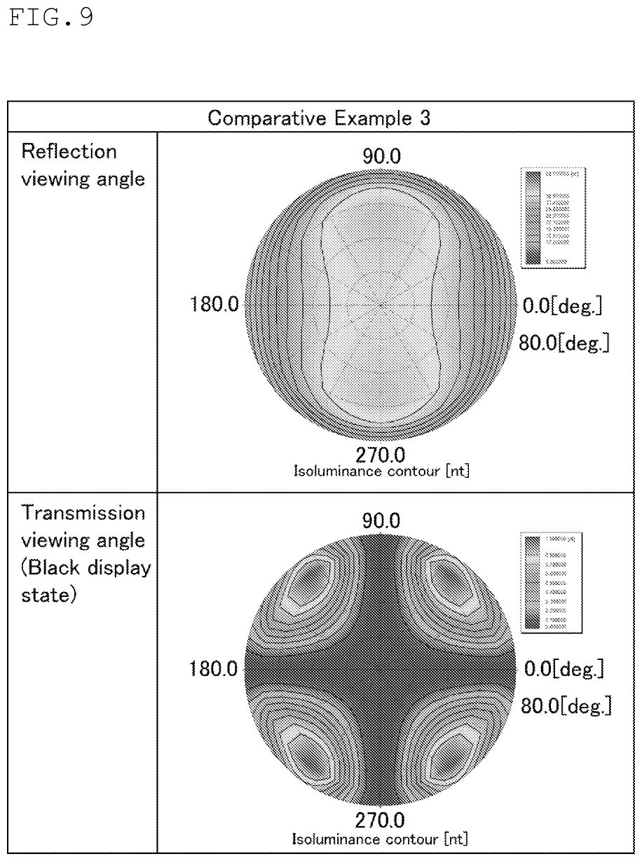

The front transmittance of the liquid crystal display device in the white display state was determined by calculating the transmittance in the normal direction (polar angle of 0°) of the screen of the liquid crystal panel in the white display state. The transmittance was the spectral transmittance in the visible range (wavelengths from 380 nm to 780 nm) calculated with a liquid crystal optical simulator (available from Shintech Inc., product name: LCD-MASTER). The front transmittances in the examples and comparative examples are shown in Table 2 as relative values with the front transmittance in Comparative Example 1 taken as 1.

| | | | | | Comparative | Comparative | Comparative |
|---|---|---|---|---|---|---|---|
| | | Example 1 | Example 2 | Example 3 | Example 1 | Example 2 | Example 3 |
| Cross-sectional view | | FIG. 1 | FIG. 2 | FIG. 3 | FIG. 19 | FIG. 20 | FIG. 20 |
| Second | R (nm) | — | — | 275 | — | — | — |
| retardation layer | Rth (nm) | — | — | 303 | — | — | — |
| | NZ | — | — | 1.6 | — | — | — |
| First | R (nm) | 0 | 275 | 275 | — | 0 | 275 |
| retardation layer | Rth (nm) | 250 | 303 | 303 | — | 250 | 303 |
| | NZ | — | 1.6 | 1.6 | — | — | 1.6 |

| | | | | | | |
|---|---|---|---|---|---|---|
| Type of third polarizer | A | A | A | — | — | — |
| Type of second polarizer | A | A | A | A | A | A |
| Type of first polarizer | A | A | A | A | A | A |
| Viewing angle characteristics | FIG. 4 | FIG. 5 | FIG. 6 | FIG. 7 | FIG. 8 | FIG. 9 |
| Front transmittance (white | 0.917 | 0.917 | 0.917 | 1.000 | 1.000 | 1.000 |
| display state) | | | | | | |

As shown in FIG. 4 to FIG. 9, the reflectances in the white display state in Examples 1 to 3 were lower than in Comparative Examples 1 to 3. Also, the transmittances of the liquid crystal display devices of Examples 1 to 3 in the black display state were lower and the light leakage was less than in Comparative Examples 1 to 3. In particular, the liquid crystal display device of Example 3 in which the slow axes of the two retardation layers were perpendicular to each other exhibited a low reflectance in the white display state and little light leakage.

Unlike Comparative Examples 1 to 3, the liquid crystal display devices of Examples 1 to 3 showed a low level of unnecessary reflection in observation in a bright environment. In particular, in observation from an oblique direction, the level of unnecessary reflection was low. Also, Examples 1 to 3 more increased the contrast ratio and thus more improved the viewability than Comparative Example 1 since light leakage in the black display state in Examples 1 to 3 was less than in Comparative Example 1.

### (Measurement of Internal Reflectance)

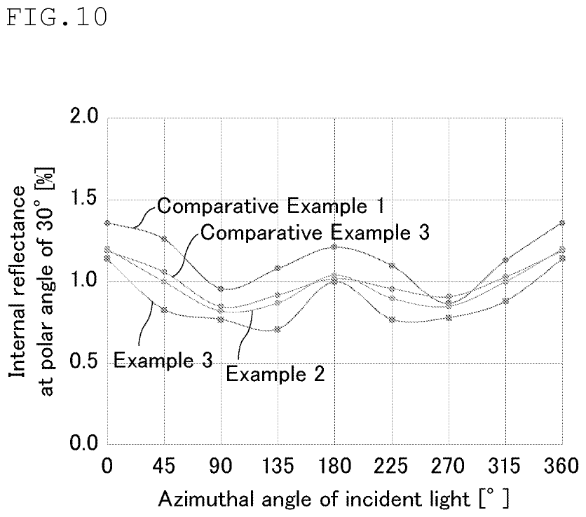

The liquid crystal display devices of Examples 2 and 3 and Comparative Examples 1 and 3 were subjected to measurement of internal reflectance at a polar angle of 30°. FIG. 10 shows the results. The measurement was performed with a variable angle photometer (available from Nippon Denshoku Industries Co., Ltd., product name: GC5000L). FIG. 10 is a graph showing the measurement results of internal reflectance at a polar angle of 30° for light incident at various azimuthal angles, in the liquid crystal display devices of Examples 2 and 3 and Comparative Examples 1 and 3. The internal reflectance herein is obtained by subtracting the surface reflectance (the surface reflectance of the outermost polarizer) from the reflectance of the liquid crystal display device in the white display state. The reflectance of the outermost polarizer of each liquid crystal display device was 4%.

As shown in FIG. 10, the liquid crystal display devices of Examples 2 and 3 caused a lower level of unnecessary reflection in observation in a bright environment than those in Comparative Examples 1 and 3, and thus provided the constant quality of black display. The liquid crystal display devices of Examples 2 and 3 and Comparative Examples 1 and 3 were actually produced and they were observed in a bright environment with 1000 lux. The observation results were confirmed to be the same as the calculation results.

### Examples 1-2 to 1-7

Polarizers with different transmittances and degrees of polarization shown in Table 1 were used to produce the liquid crystal display devices of Examples 1-2 to 1-7. The liquid crystal display devices of Examples 1-2 to 1-7 each have the same configuration as in Example 1, except for the performances of the third polarizer and the second polarizer. The configurations in Examples 1-2 to 1-7 are as shown in Table 3.

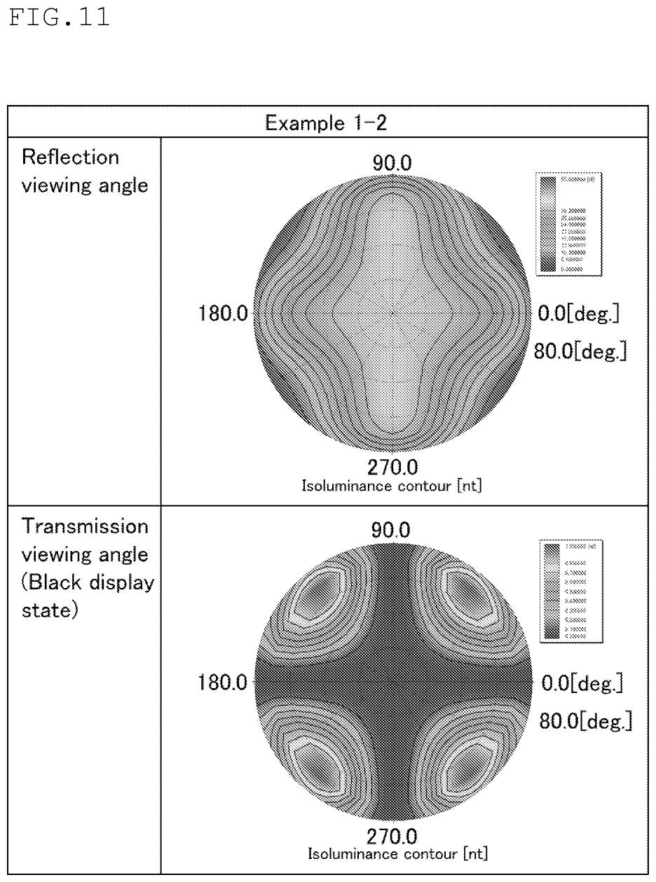

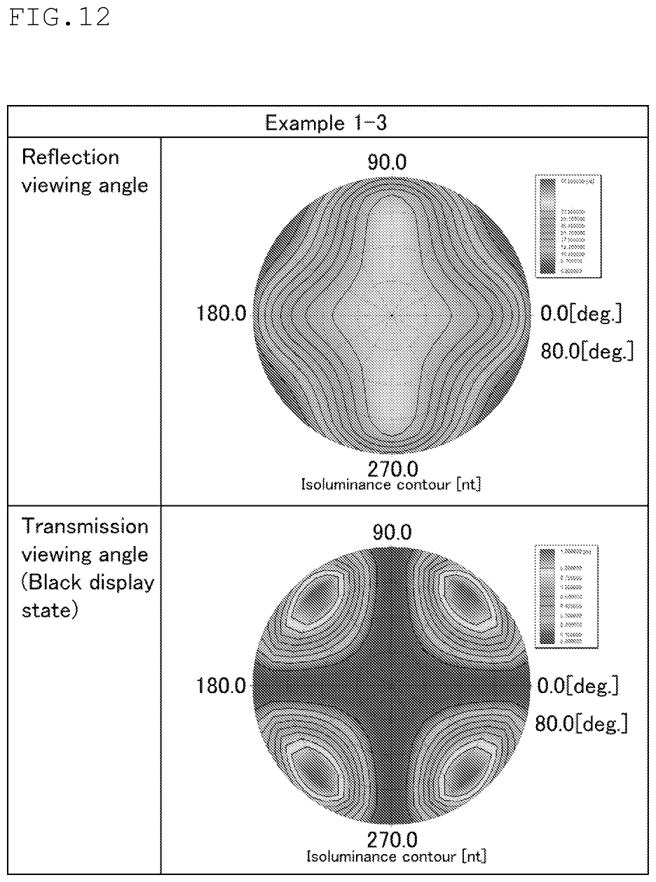

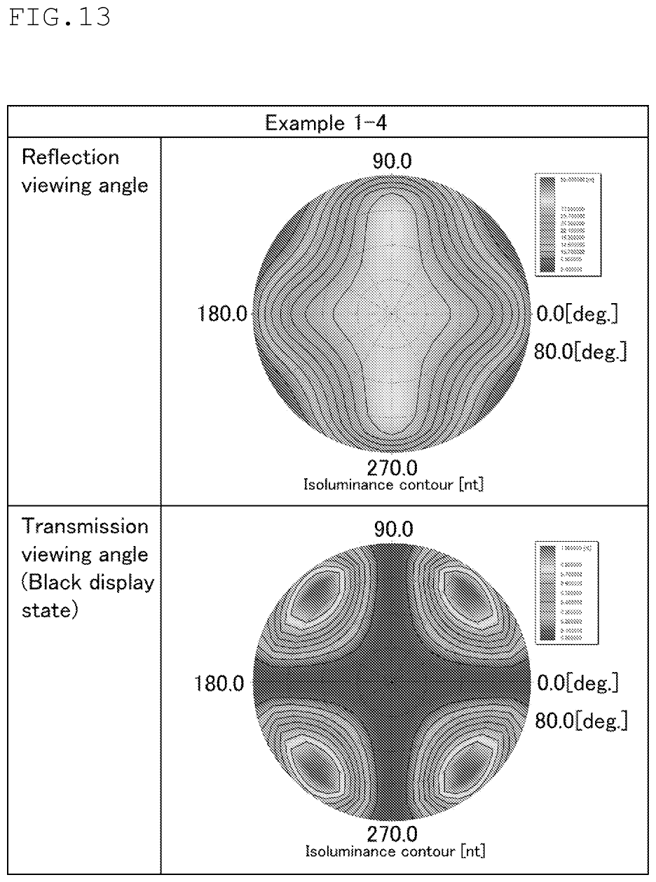

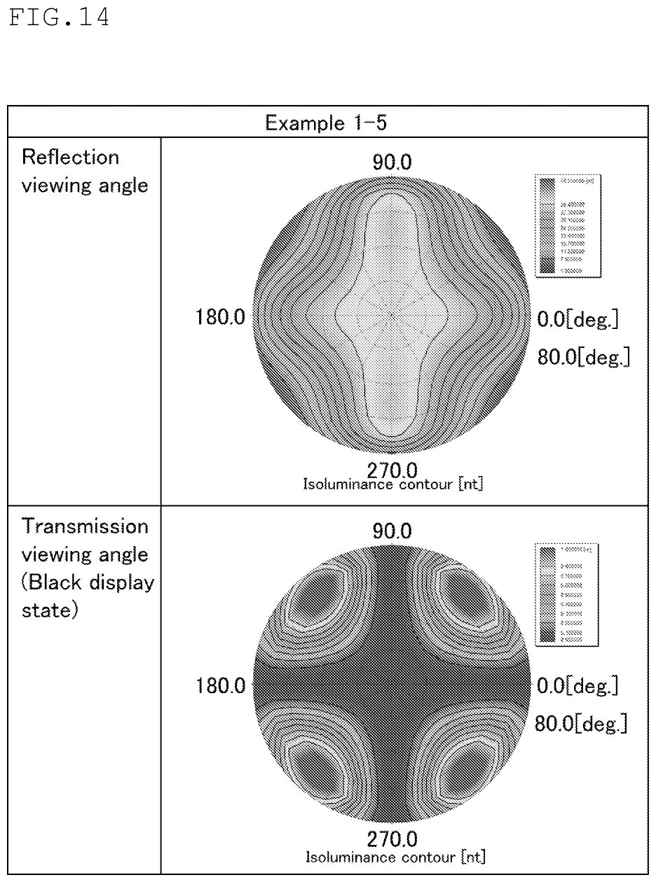

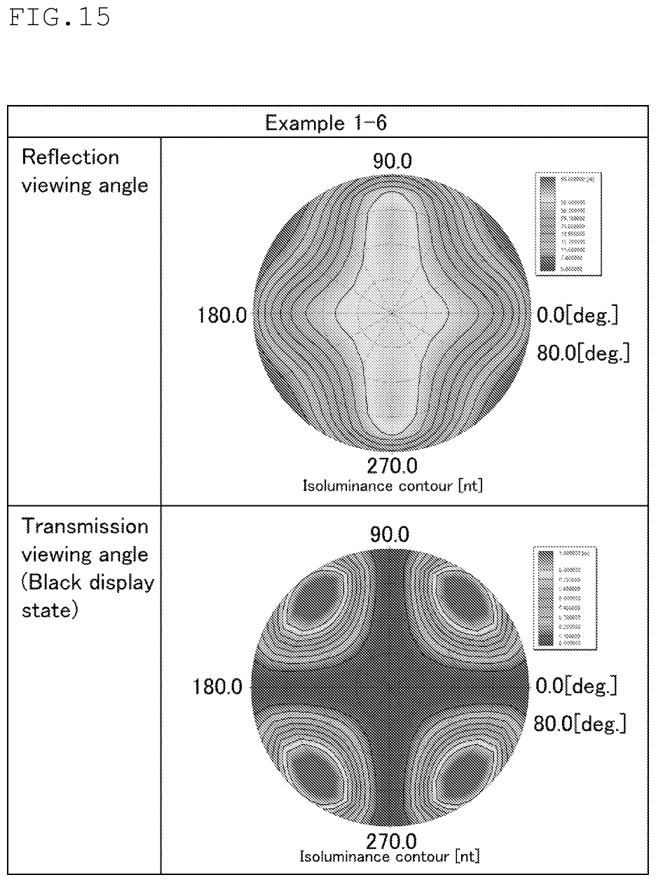

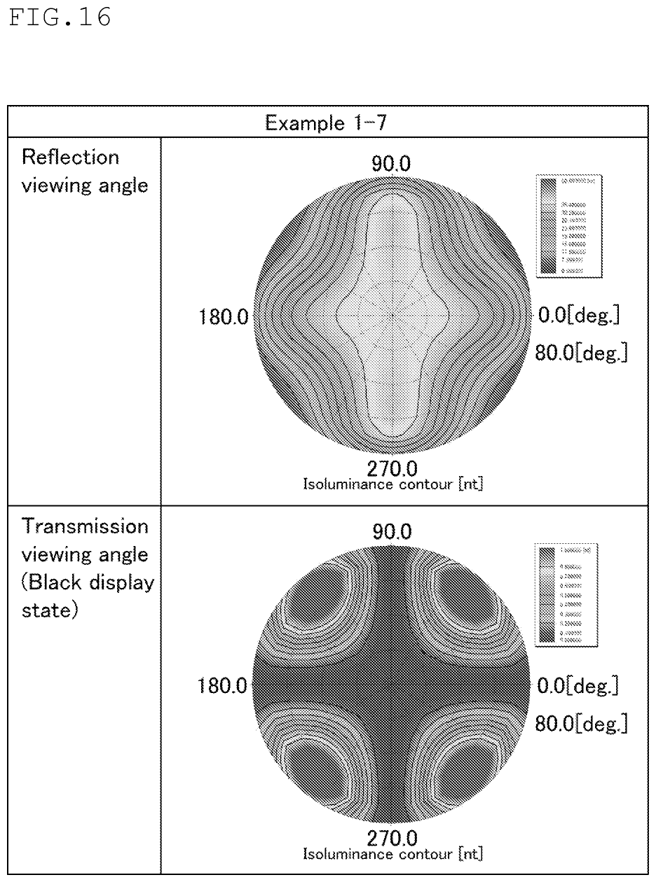

As in Example 1, the reflection viewing angle, the transmission viewing angle in the black display state, and the front transmittance in the white display state (value relative to Comparative Example 1) of each of the liquid crystal display devices were calculated. The calculated front transmittances of the liquid crystal display devices in the white display state are shown in Table 3. The resulting viewing angle characteristics are shown in FIG. 11 to FIG. 16. FIG. 11 to FIG. 16 respectively correspond to the results of the liquid crystal display devices of Examples 1-2 to 1-7 and each include a contour plot showing the reflection viewing angle and a contour plot showing the transmission viewing angle in the black display state.

| | | Example 1 | Example 1-2 | Example 1-3 | Example 1-4 | Example 1-5 | Example 1-6 | Example 1-7 |
|---|---|---|---|---|---|---|---|---|
| Cross-sectional view | | FIG. 1 | FIG. 1 | FIG. 1 | FIG. 1 | FIG. 1 | FIG. 1 | FIG. 1 |
| Second | R (nm) | — | — | — | — | — | — | — |
| retardation layer | Rth (nm) | — | — | — | — | — | — | — |
| | NZ | — | — | — | — | — | — | — |
| First | R (nm) | 0 | 0 | 0 | 0 | 0 | 0 | 0 |
| retardation layer | Rth (nm) | 250 | 250 | 250 | 250 | 250 | 250 | 250 |
| | NZ | — | — | — | — | — | — | — |

| | | | | | | | |
|---|---|---|---|---|---|---|---|
| Type of third polarizer | A | B | C | D | C | C | B |
| Type of second polarizer | A | A | A | A | B | C | D |
| Type of first polarizer | A | A | A | A | A | A | A |
| Viewing angle characteristics | FIG. 4 | FIG. 11 | FIG. 12 | FIG. 13 | FIG. 14 | FIG. 15 | FIG. 16 |
| Front transmittance (white | 0.917 | 0.949 | 0.957 | 0.966 | 1.000 | 1.000 | 1.000 |
| display state) | | | | | | | |

As shown in FIG. 4 and FIG. 11 to FIG. 16, the liquid crystal display devices of Examples 1-2 to 1-7, with the third polarizer and/or the second polarizer higher than the first polarizer in transmittance, exhibited a higher transmittance in the white display state than the liquid crystal display device of Example 1. In particular, in Examples 1-5 to 1-7, the transmittance in the white display state was further increased.

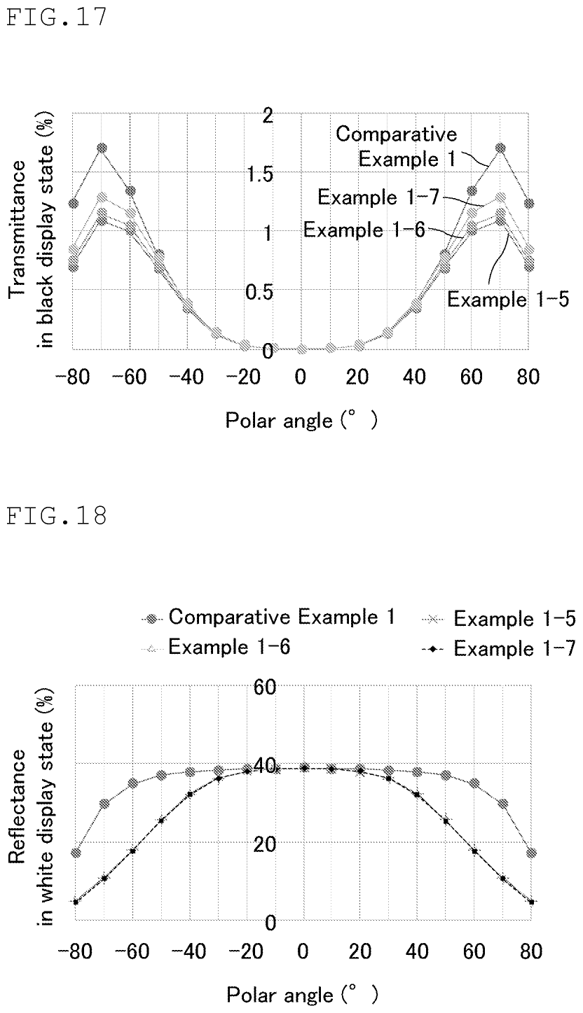

The results of Examples 1-5 to 1-7 show that the second polarizer is preferably higher than the third polarizer in performance. This is presumably because of the following conditions (i) and (ii), which are described with reference to FIG. 17 and FIG. 18. FIG. 17 is a graph showing the measurement results of transmittance in the black display state at various polar angles in observation of the liquid crystal display devices of Examples 1-5 to 1-7 and Comparative Example 1 at an azimuthal angle of 45°. FIG. 18 is a graph showing the measurement results of reflectance in the white display state at various polar angles in observation of the liquid crystal display devices of Examples 1-5 to 1-7 and Comparative Example 1 at an azimuthal angle of 45°.
(i) Since the second polarizer and the first polarizer are arranged in crossed Nicols and they collaboratively determine the transmissive display performance of the display device, the second polarizer preferably exhibits high performance. As shown in FIG. 17, comparison among Examples 1-5, 1-6, and 1-7 shows that the liquid crystal display device of Example 1-5 had the lowest transmittance in the black display state and least light leakage.
(ii) The second polarizer and the third polarizer are arranged in parallel Nicols and they collaboratively achieve the louver effect to determine the anti-reflection performance of the liquid crystal display device. This means that the anti-reflection performance does not change as long as the second polarizer and the third polarizer, even when one of them is higher than the other in performance or vice versa, collaboratively exhibit a performance equivalent to the performance exhibited by a hypothetically single polarizer defined by the two polarizers. In other words, the performance distribution between the second polarizer and the third polarizer is rather not important. As shown in FIG. 18, while the reflection reduction effect was achieved in all of Examples 1-5, 1-6, and 1-7 as compared with Comparative Example 1, the graph lines of Examples 1-5, 1-6, and 1-7 overlap one another, which shows that there was no difference in reflection reduction effect among Examples 1-5, 1-6, and 1-7.

### REFERENCE SIGNS LIST

1A, 1B, 1C, 100A, 100B: liquid crystal display device
11, 111: first polarizer
12, 112: second polarizer
13: third polarizer
14, 114: fourth polarizer (reflective polarizer)
20, 120: liquid crystal panel
31, 131: first retardation layer
32: second retardation layer
40, 140: backlight

What is claimed is:

1. A liquid crystal display device comprising, sequentially in the following order from a back surface side:
a first polarizer;
a liquid crystal panel;
a second polarizer;
a first retardation layer; and
a third polarizer,
wherein light transmitted in an oblique direction between the second polarizer and the third polarizer is elliptically polarized light.

2. The liquid crystal display device according to claim 1,
wherein a transmittance of at least one of the second polarizer or the third polarizer is not lower than a transmittance of the first polarizer.

3. The liquid crystal display device according to claim 1,
wherein a degree of polarization of at least one of the second polarizer or the third polarizer is not higher than a degree of polarization of the first polarizer.

4. The liquid crystal display device according to claim 1,
wherein the second polarizer and the third polarizer are different in transmittance or degree of polarization.

5. The liquid crystal display device according to claim 1,
wherein the second polarizer and the third polarizer are linear polarizers, and
a transmission axis of the second polarizer and a transmission axis of the third polarizer are parallel to each other.

6. The liquid crystal display device according to claim 5,
wherein a difference between a transmittance for light having passed through the second polarizer and the third polarizer and a transmittance of the first polarizer is not more than 1%, or
a difference between a degree of polarization of light having passed through the second polarizer and the third polarizer and a degree of polarization induced by the first polarizer is not more than 1%.

7. The liquid crystal display device according to claim 1,
wherein the second polarizer is higher than the third polarizer in transmittance or degree of polarization.

8. The liquid crystal display device according to claim 1, further comprising a second retardation layer between the second polarizer and the third polarizer.
